(19) United States
(12) Patent Application Publication
(10) Pub. No.: US 2011/0196735 A1
(43) Pub. Date: Aug. 11, 2011

(54) SYSTEM AND METHOD FOR MEASURING EFFECTIVENESS OF ELECTRONICALLY PRESENTED ADVERTIZING

(76) Inventors: Gustav von Sydow, Goteborg (SE); Theo Hultberg, Goteborg (SE); John Sjölander, Goteborg (SE)

(21) Appl. No.: 12/700,844

(22) Filed: Feb. 5, 2010

(51) Int. Cl. G06Q 30/00; G06Q 10/00; G06F 15/16; G06F 3/048; G06F 9/44; G06F 21/22

(52) U.S. Cl. 705/14.43; 705/14.41; 709/203; 715/764; 717/115; 726/26

(57) ABSTRACT

Disclosed in one general aspect is a method of evaluating the presentation of advertising content on end-user computer displays that includes sending an integrated advertisement program that includes advertising content through a computer network to end-user computers in response to requests from browsers running on the end-user computers. The integrated advertisement program is accessed on each of the end-user computers after it is received from a server on that computer. The integrated advertisement program determines a display attribute of the advertising content in the integrated advertisement program on each of the end-user computers, and reports the detected display attribute from each of the end-user computers through the computer network to a monitoring application.

### FIELD OF THE INVENTION

This invention relates to methods and apparatus for measuring the effectiveness of electronically presented advertisements and advertising campaigns, such as web-based advertisements and advertising campaigns.

### BACKGROUND OF THE INVENTION

Most of the hundreds of billions spent on advertising every year have one thing in common—they passed thru the hands of an advertizing agency. Agencies decide what is said, where it's said and how it's said. Making sure that agencies understand the constraints and possibilities of online advertising is therefore an important component to maximizing value for advertisers, and thereby maximizing revenues for publishers.

Advertising agencies do extensive measuring of their own to understand their campaigns. Prior to release, they use focus groups to ensure they chose the best formats. And post-release market surveys ensure the advertisements were seen. But they still tend to rely on gut feeling to assess if a web advertisement will do the job or not despite the existence of technologies that track web traffic. Indeed, while a number of traffic tracking tools are available from companies like Google, Microsoft, Adobe, and Yahoo, these have not been universally adopted by advertizing agencies. These agencies therefore often continue to rely on their experience and gut feeling in preparing even relatively large-scale advertizing campaigns.

### SUMMARY OF THE INVENTION

In one general aspect, the invention features a method of evaluating the presentation of advertising content on end-user computer displays that includes sending an integrated advertisement program that includes advertising content through a computer network to end-user computers in response to requests from browsers running on the end-user computers. The integrated advertisement program is accessed on each of the end-user computers after it is received from a server on that computer. The integrated advertisement program determines a display attribute of the advertising content in the integrated advertisement program on each of the end-user computers, and reports the detected display attribute from each of the end-user computers through the computer network to a monitoring application.

The step of determining can determine visibility display attributes that each relate to whether at least some of the content from the integrated advertising program is displayed on a display associated with an end-user computer. The step of detecting a display visibility attribute can detect a measure of how much surface area of the advertising content from the integrated advertisement program is visible on the end-user computer. The step of determining can determine positional display attributes that each relate to a position where the content from the integrated advertising program is presented on a display associated with an end-user computer. The step of determining can determine positional display attributes based on a position of a canvas containing the content from the integrated advertising program within a browser window. The step of detecting a display attribute can detect a display duration attribute that relates to how long the advertising content from the integrated advertisement program is visible on the end-user computer. The method can further include the steps of aggregating the reported display attributes. The method can further include the steps of displaying aggregated display attribute information resulting from the step of aggregating on a computer output device. The step of displaying can display the information graphically. The step of aggregating can derive separate measures of the reported display attributes for different types of content included in different integrated advertisement programs and further include the step of comparing the separate measures. The method can further include the step of detecting personal attributes of groups of end users based on the step of reporting with the step of aggregating deriving separate measures of the reported display attributes for the different end-user groups. The step of detecting can detect demographic and regional personal attributes. The step of detecting can include accessing the network address of the end-user computer. The step of aggregating can be user-configurable. The method can further include the step of combining reporting links with the content in the integrated advertisement program with the step of combining and the step of aggregating being performed for a same organization. The method can further include the step of creating the content to be included in the integrated advertisement program, with the steps of creating, combining, and aggregating being performed for a same organization to provide feedback on the effectiveness of content created in the step of creating. The integrated advertisement program can be written to operate in a multimedia execution environment. The integrated advertisement program is can be an ActionScript program. The integrated advertisement program can include embedded JavaScript. The method can further include the steps of combining reporting links with the content in the integrated advertisement program and then providing the integrated advertisement program to different advertisement distribution providers. The method can further include the step of storing the integrated advertisement program that includes advertising content on one or more ad servers connected to a computer network and serving the advertisement program from the ad servers. The step of reporting can operate between the end-user computers and a monitoring server that is separate from the ad servers. The step of sending can send the advertisement program in a compiled binary format. The step of reporting can use non-cleartext reporting links embedded in the advertisement program. The step of sending can send an advertisement program that consists of a single file that includes both content and reporting links. The step of reporting can include reporting a validation key. The step of reporting a validation key can report a key that includes a portion of the key that identifies a supplier of the content for the integrated advertisement program.

In another general aspect, the invention features an apparatus for evaluating the presentation of advertising content on end-user computer displays that includes an authoring interface operative to enable a user to insert a tracking client with visibility attribute determining logic in an integrated advertisement program that includes advertising content. An aggregation subsystem is operative to receive and aggregate display attributes of the advertizing content from the visibility attribute determining logic in the tracking client in the integrated advertising program. A viewer is operative to display aggregated display attribute information from the aggregation subsystem.

In preferred embodiments the apparatus further can include further viewers and further authoring interfaces operative to insert further tracking clients that include different campaign identifiers, with the aggregation subsystem further including distribution logic operative to receive and distribute visibility information to different viewers based on the campaign identifiers. At least some of the authoring interfaces can each be located at one of a plurality of different advertising agencies with one of the viewers, with the aggregation and distribution subsystem being located at a location that is geographically remote from the advertising agencies. The authoring interface can be further operative to insert additional interaction detection logic in the tracking client.

In a further general aspect, the invention features an apparatus for evaluating the presentation of advertising content on end-user computer displays that includes tracking client insertion means for inserting means for determining visibility attributes in an integrated advertisement means that includes advertising content, means for receiving and aggregating display attributes of the advertizing content from the means for determining visibility attributes in the integrated advertising program, and means for displaying aggregated display attribute information from the means for receiving and aggregating.

Systems according to the invention can be particularly helpful in developing effective advertizing campaigns because they can quickly provide feedback about the campaigns directly to the creative agencies that developed them. This feedback can help them to rapidly understand why a particular campaign is less successful than expected, and take corrective action. Advertizing agencies can also gain deeper insights into what types of advertizing work for their different clients by tracking and comparing different campaigns. And because the feedback is provided directly to the agency, the agency can determine itself which metrics are important and exert finer control over the process.

Systems according to the invention can also be less expensive and simpler to use than existing solutions. They can be provided as a one-part solution that can be used in connection with an agency's creative authoring tools, rather than as a partial tool that needs to interact with one or more different systems. And by bypassing third-party data collection (e.g., using JavaScript on a web page), systems according to the invention can reduce the overall cost associated with operating the system.

Systems according to the invention can also operate more robustly by providing display attribute tracking functionality in an integrated advertising program. This can prevent downstream systems from redirecting or disabling messages from the program, and can result in increased independency from ad networks or media site integration.

Systems according to the invention can also provide more meaningful metrics for online advertisements. Because they directly provide information about display attributes, these systems can supply advertising agencies with more relevant information than they might from only the Exposure and Click Thru metrics that are in common use. These metrics are easy to measure and they relate to the CPM (cost per 1000 impressions/downloads) and CPC (cost per click) business standards of paying for advertising. But they are really measurements of what you've bought, and while they can be highly relevant for billing from an ad server, they do not tend to be relevant metrics for the success of an advertising campaign. They are instead akin to the circulation of a newspaper, which is not generally a relevant metric for the success of a print campaign. Systems according to the invention can replace or supplement the Exposure and Click Thru metrics with visibility information that allows the advertising agencies to understand that an advertisement was actually seen and that the message of the advertisement was received, which can be critical for an advertisement's success.

### BRIEF DESCRIPTION OF THE DRAWING

FIG. 1 is a block diagram of an illustrative advertising system according to the invention;

FIG. 2 is a block diagram of an integrated advertising program for use with the system of FIG. 1;

FIG. 3 is a diagram showing an illustrative dashboard screen view for the system of FIG. 1;

FIG. 4 is a flowchart illustrating operation of the system of FIG. 1;

FIG. 5 is a diagram showing a progression in which a relationship between and advertisement and a viewport changes;

FIG. 6 is a screenshot of an tracking client installation and configuration help screen for the system of FIG. 1, which is presented to users when no client has been installed;

FIG. 7A is a screenshot of a advertisement upload test screen for use with the system of FIG. 1; and

FIG. 7B is a screenshot of a advertisement verification test screen for use with the system of FIG. 1.

### DETAILED DESCRIPTION OF AN ILLUSTRATIVE EMBODIMENT

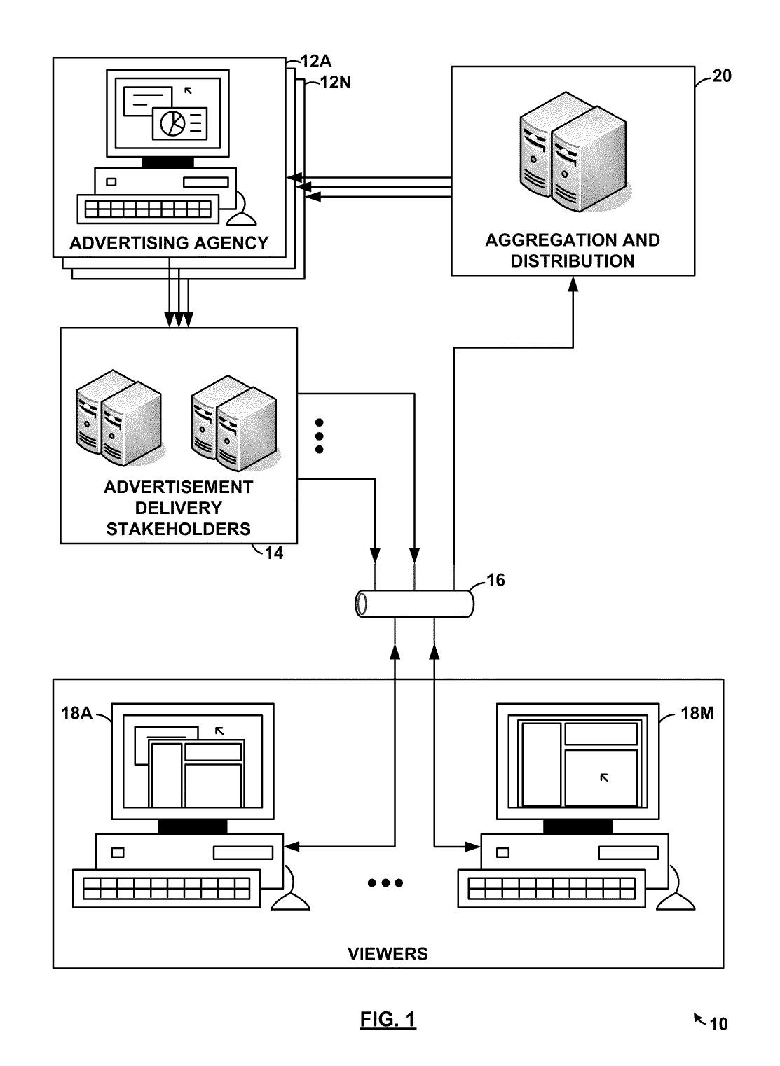

Referring to FIG. 1, an advertising system 10 according to the invention generally operates between one or more advertising agencies 12A . . . 12N, one or more advertisement delivery stakeholders 14, viewers 18A . . . 18N, and an aggregation and distribution subsystem 20. The advertising agencies typically employ one or more computers and software applications to author and produce advertisements in formats that can be presented via one or more media, such as through the World Wide Web. These advertisements are then provided to one or more of a variety of different kinds of intermediate advertisement delivery stakeholders. These can include media agencies, traders, ad servers, ad networks, ad exchanges, publishers, and creative optimization services.

Viewers 18A . . . 18M typically receive the advertisements via a digital computer communication network, such as the internet or a digital wireless mobile telephone network. The advertisements are generally presented by a browser using well-known, web-based techniques, although it is possible to deliver advertisements in other ways, such as through the use of specialized mobile applications.

The advertisements can be presented in a variety of different ways, such as as banners, pop-ups, or in-text advertizing. They are generally presented in connection with other media site content that the user is viewing, such as a news story on a news site. Often, however, the advertisements are placed such that they may be obscured from view depending on a variety of factors, such as how a browser viewport is positioned with respect to the rendered page canvas and how the browser window is scrolled.

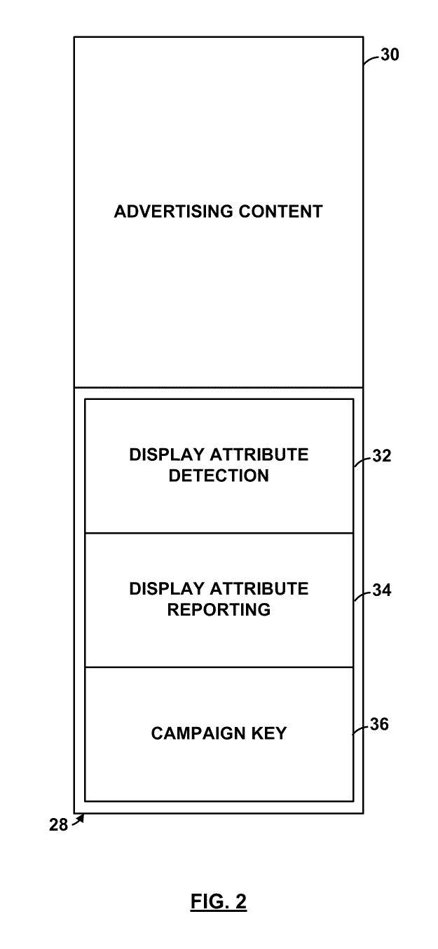

Referring also to FIG. 2, the advertisements are generally delivered in the form of an integrated advertisement program 28 that can be executed on the viewer's computer, such as by its operating system, a browser, or a browser plug-in. Its contents can include advertising content 30, and a client that can include display attribute detection logic 32, display attribute reporting logic 34, and an identifier 36, such as a campaign key. The display attribute detection logic is a portion of the integrated program that detects one or more display attributes that can provide information about the user's exposure to the advertisement. This can include, for example, a canvas size, a measure of the amount of the surface area of the advertisement is visible, how long the advertisement is visible, and/or on what part of the viewport it is visible. The display attribute reporting logic 34 is a part of the program that reports the display attributes to the aggregation and distribution subsystem, preferably in association with an identifier, such as the campaign key 36. Other information can also be detected and reported, such as date, time, browser type, a session identifier, and an advertisement ID.

The aggregation and distribution subsystem 20 aggregates and stores the information that it receives from the display attribute reporting logic in integrated advertisement programs run by users distributed across the target audiences. It can process the received data in a number of ways, including tallying, time-stamping, and categorizing results, separating results according to campaign key, and associating the data with other information received about the viewer and/or his or her computer. The additional information can include geographic and demographic information, which can be obtained in different ways, such as based on lookup of the viewer's Internet Protocol (IP) address.

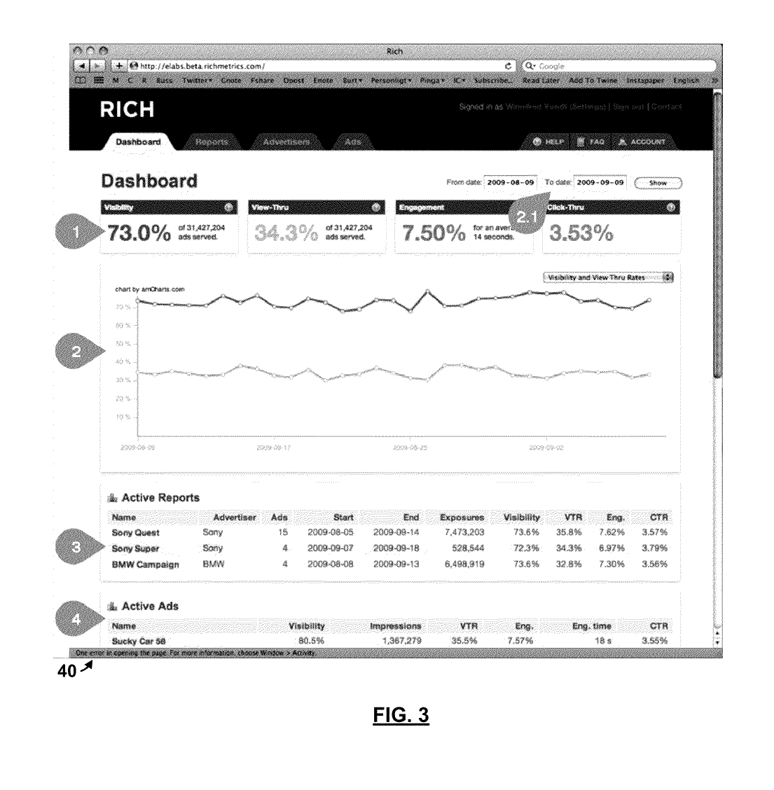

Referring also to FIG. 3, the aggregation and distribution subsystem 20 can report the processed data in a variety of ways. In the presently preferred embodiment, it relays the processed display attribute data to an interactive result viewer, which can run in a browser by the adverting agency responsible for the advertising content that it relates to. This viewer can present the data in formats that allow the agency to understand how advertisements in a campaign are being displayed on viewer computers.

The dashboard view 40 shown in FIG. 3, for example, presents a summary bar 1 that shows metrics of the reports that the user has access to. A chart 2 shows different metrics compared to each other over a selectable time period, such as the last month. An active report list 3 shows recent active reports (reports with recent activity) with summary data for each. An active advertisements list 4 lists recent active individual advertisements with summary data for each.

Key metrics for the summary bar 1 include:

1. Visibility: The percentage of downloaded advertisements where the user had an opportunity to see the advertisement because it was visible in the browser view-port.

2. View-Thru: The percentage of the visible advertisements that were actually seen, not necessarily noticed or processed.

3. Engagement: The percentage of visible advertisements where user engagement is recorded, and the average engagement time.

4. The percentage of visible advertisements that were clicked upon, sending the viewer to the advertisement's campaign site.

The systems can offer a variety of other metrics. These can include attention, which is the time during which the viewer noticed the advertisement, and visibility time, which is the average time the advertisement was visible. Other possible metrics are described generally below.

### Exposures

An exposure is the loading of an advertisement on a website. In this embodiment an exposure is only recorded if an advertisement has completed loading and has had time to send its first request (the exposure request) to the aggregation server. The ad server will report the number of exposures as the number of times the advertisement file has been requested from their severs. The client request is instead sent as soon as the advertisement has loaded completely. That means that its count will differ from the ad server's since the user can leave the page before the advertisement has loaded. Note that the ad server will log an exposure on advertisement download, while the system logs the exposure after a subsequent exposure request.

### Impressions and Visibility

If an advertisement has loaded and has been visible on the page for at least a second (the shortest duration measured in this embodiment) it is considered an impression. The visibility is the total time the advertisement was visible during a session.

### Frequency

The number of impressions per user. How many times was the user exposed to an advertisement in the report? It can be segmented so that how many times a user was exposed to an advertisement, format, site etc. are counted.

### Attention/View-Thru

An advertisement can be visible without capturing anyone's attention. Based on the engagement (see below) and the number of impressions the system calculates an attention score for a campaign. This can be done generally based on patterns of user activity, such as mouse-overs, combined with visibility metrics.

### Engagement

Engagement is a measure of how many sessions that were interactive, i.e., how many sessions saw user interaction in the form of mouse overs, clicks, etc. Engagement is actually two metrics: one that says how many sessions had any engagement at all, and one that says how long the interactive part of the session was.

### Click Thru

If the user clicks on an advertisement and is directed to a new page (a campaign site, or some other page set up by the advertiser) it's a “click thru”.

### Actions

The client allows for custom actions to be sent when an event is triggered a predefined user action. Actions are then displayed as separate metrics in the report.

### Categories and Segments

In addition to showing sums for all the metrics the system shows them by which sites the advertisements were on, the ads' dimensions, the users' city and country, etc. These are called categories and the values are called segments. Thus “Site” is a category and “nytimes.com” is a segment in that category.

### Custom Categories and Segments

In some circumstances it's desirable to be able to look at the metrics divided into custom segments. To make this possible, advertisements can send custom segment data, which is assembled and shown in the report as a custom category. The segment data can be based on the part of a website on which the advertisement is shown (on the sports pages, the culture section or the front page, for example) or some other piece of information that is available when the advertisement is active.

One or more separate views can also be provided to create, search for, and view reports. To create a new report, the user names the report, selects what advertiser to include (if any), selects which time period to cover, and selects which keywords to cover. The result viewer will then create a report covering this data (advertiser, dates and keywords) and add it to the list of accessible reports.

One or more separate views can also be provided to add and manage advertisers. Advertisers are given a name in the system, and the domains that belong to the advertiser are added to the advertiser. This lets the system automatically add advertisements connected to these domains.

One or more separate views can also be provided to add and manage advertisements. A list of accessible advertisements can be shown with a brief summary. Users can search for an advertisement using partial name, advertiser and/or start and/or end date.

The system allows different users to have their own accounts. An account view can let account owners set a password for their account, list campaign keys and associated keywords, see a list of application users, invite new users, and delete users.

A new campaign key control can allow the user to create a new campaign and receive a campaign key for the new campaign. Campaign keys uniquely identify a campaign and can include measures to prevent tampering. They can be associated with keywords so that results and reports can be searched more easily.

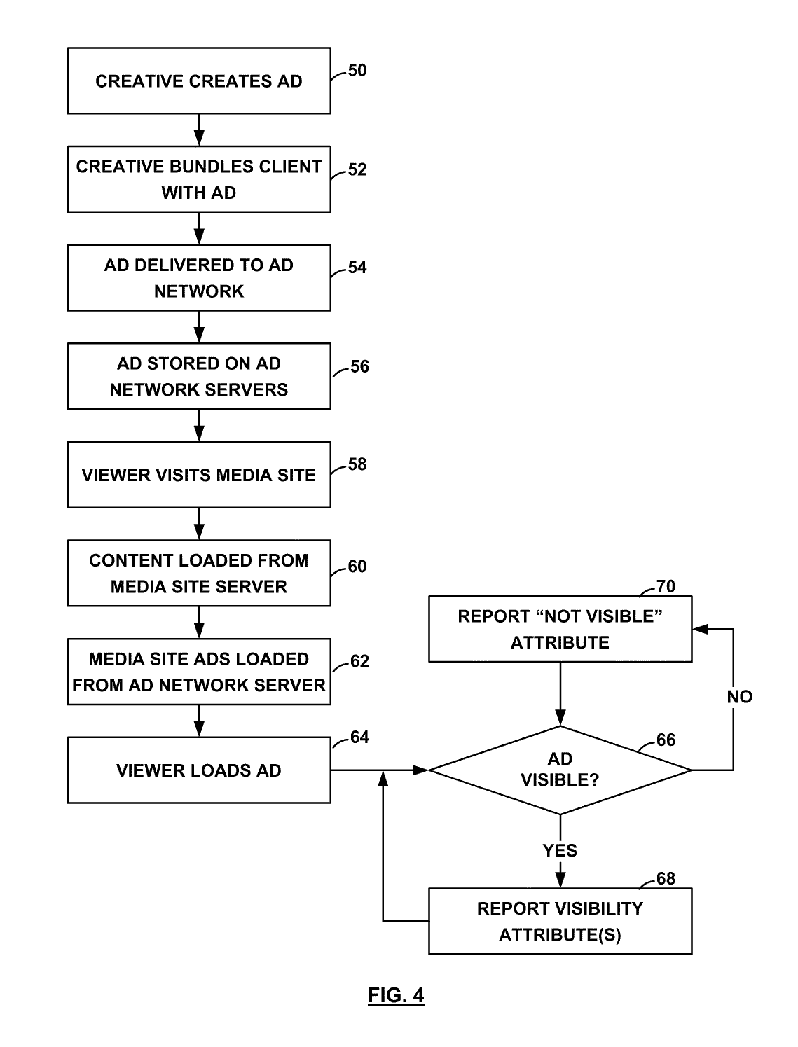

Referring to FIG. 4, overall operation of the system begins with a creative user (e.g., an advertising agency employee) creating an advertisement using one or more authoring tools, such as Adobe Flash (step 50). The creative user then bundles a client with the advertisement (step 52). The advertisement is delivered to a an advertisement delivery stakeholder such as an ad network (step 54), which stores it on its servers (step 56).

When the viewer visits a media site (step 58), which can be served by the ad network server, content is loaded from the media site server (step 60). Advertisements for the media site are also loaded from the ad network server (step 62).

The viewer then loads the advertisement (step 64). If it the advertisement is not visible, that condition is reported once (step 70). If and when the advertisement becomes visible (step 66), this condition is reported, such as via an HTTP request (step 68). Preferably, the visibility reporting includes a continuous series of pings or heartbeats that are issued as long as the advertisement is visible, a period known as a session. Heartbeats can decrease in frequency for longer periods. If the advertisement transitions from visible to invisible, this condition is reported once.

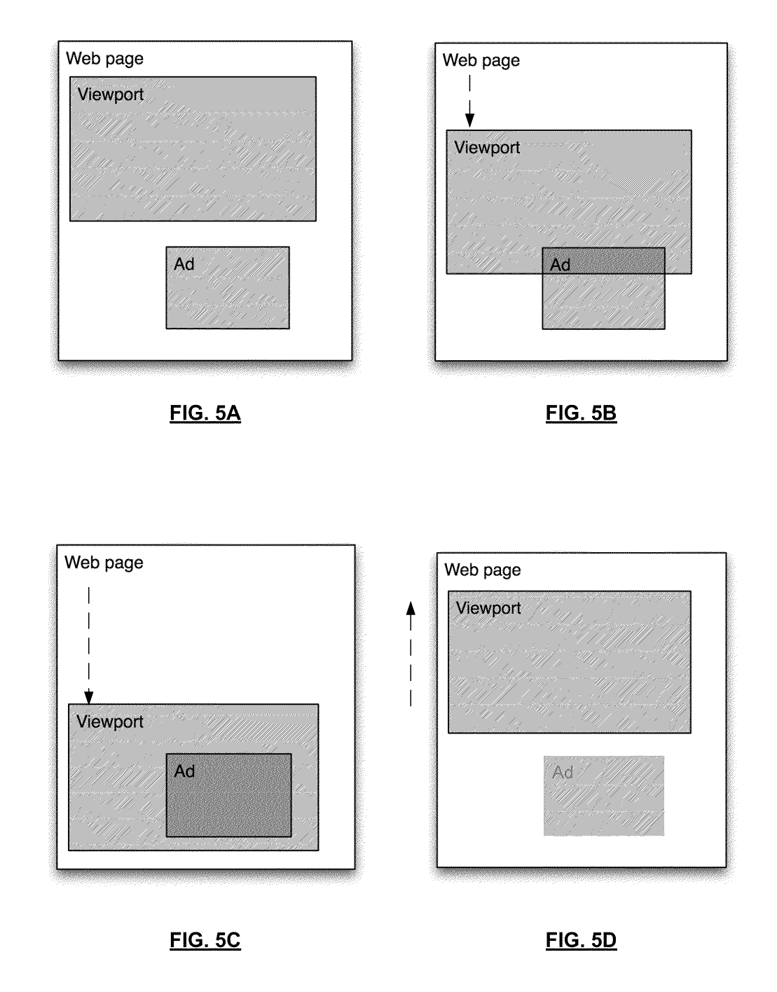

Referring to FIG. 5, Web pages can include Hypertext Markup Language (HTML) and scripts. The scripts can interactively manipulate the HTML or interact with the features of the browser. A browser consists of a viewport that shows a part of the web page canvas.

The advertisement is delivered as a file. The file is referenced from the Media site's HTML. Once the page is loaded the browser will download the images and object of the web page. Once the advertisement is loaded into the viewers browser the advertisement becomes aware, as its code starts executing in the viewers browser.

In an illustrative progression, a page is first loaded, and an advertisement is then loaded and starts executing (FIG. 5A). But since the advertisement is not yet visible it reports that condition back to the aggregation and distribution subsystem.

As the user browses the site, the advertisement becomes visible (FIG. 5B). When a sufficient part of the advertisement is visible, the advertisement starts reporting visibility back to the aggregation and distribution subsystem.

During the time that the advertisement is visible, it reports its visibility back to the aggregation and distribution subsystem (FIG. 5C).

Once the advertisement becomes non-visible in the viewer's browser, the advertisement stops reporting visibility back to the aggregation and distribution subsystem (FIG. 5D).

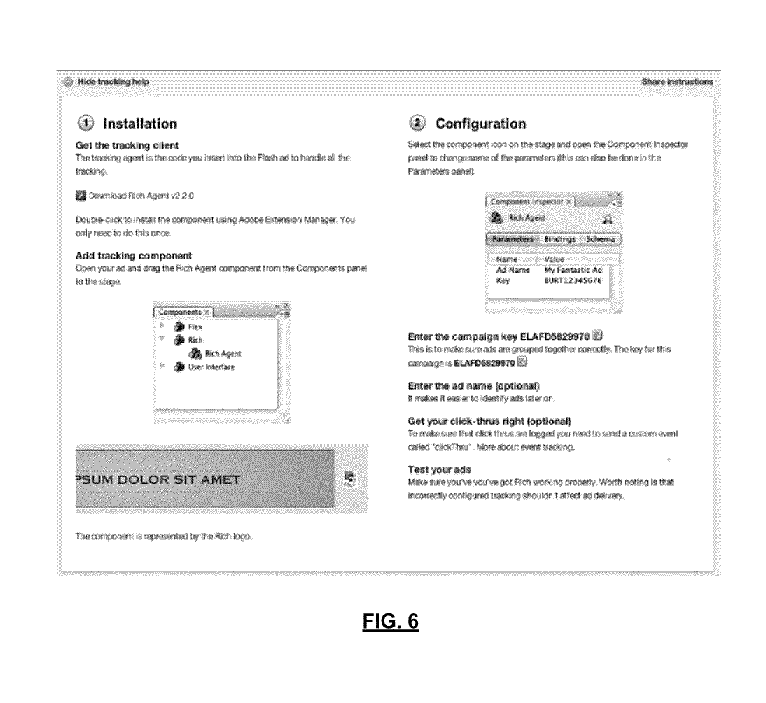

Referring to FIG. 6, in the present embodiment the advertising program is an Adobe Flash program with embedded JavaScript to perform display attribute detection and reporting. An extension package (MXP) can be used to simplify the process of creating the advertisement program and managing campaign keys and keywords.

Once the extension package has been installed, the user can access a client component. This component can be dragged to an advertisement authored in the Adobe Flash authoring environment. A component inspector panel or parameter panel can then be used to change some of the parameters, including entering a campaign key and adding one or more keywords for the advertisement—for example “burger_king” and “bk_spring09.” Campaigns with multiple advertisement units should share at least one keyword.

The client will automatically track every exposure, and send heartbeats to the aggregating/logging servers. It will also track events such as when the viewer moves the mouse over the advertisement, when the mouse leaves the advertisement again. It can track click events, as well.

The aggregation and distribution system aggregates all clicks (and mouse overs to a certain extent) into an “engagement” metric, that basically describes if users have chosen to interact with the advertisement. The system may be able to determine which event is the “click thru” (the clickTAG event) that directs users to another destination. But to make sure click thrus and other events are registered correctly the user should use predetermined event names such as clickThru.

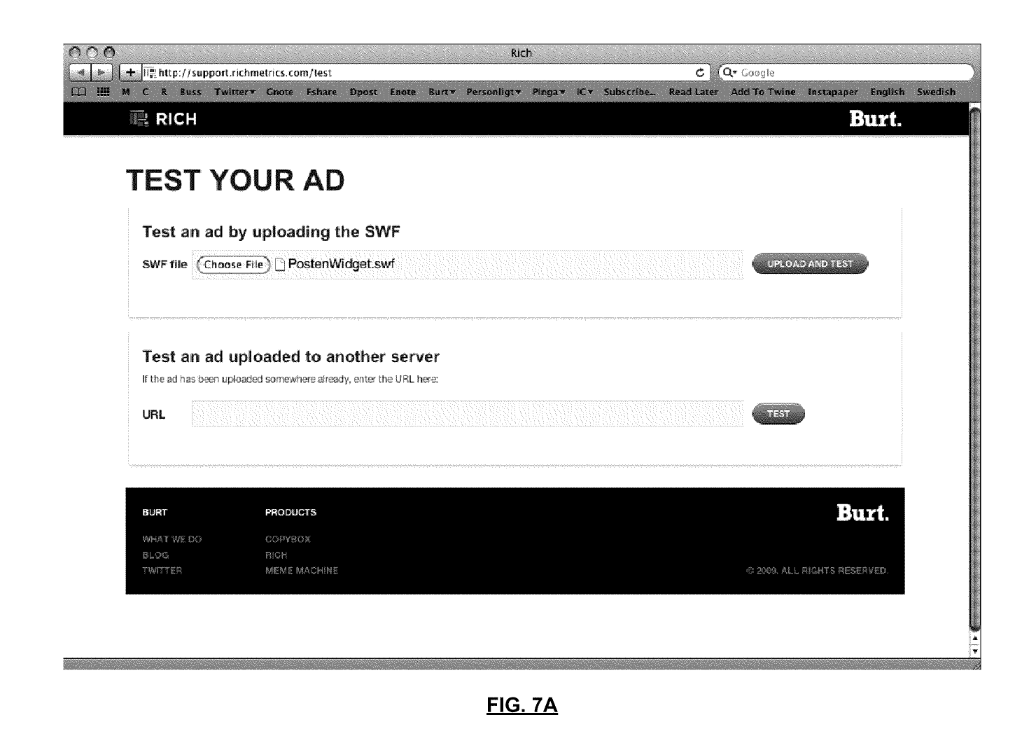

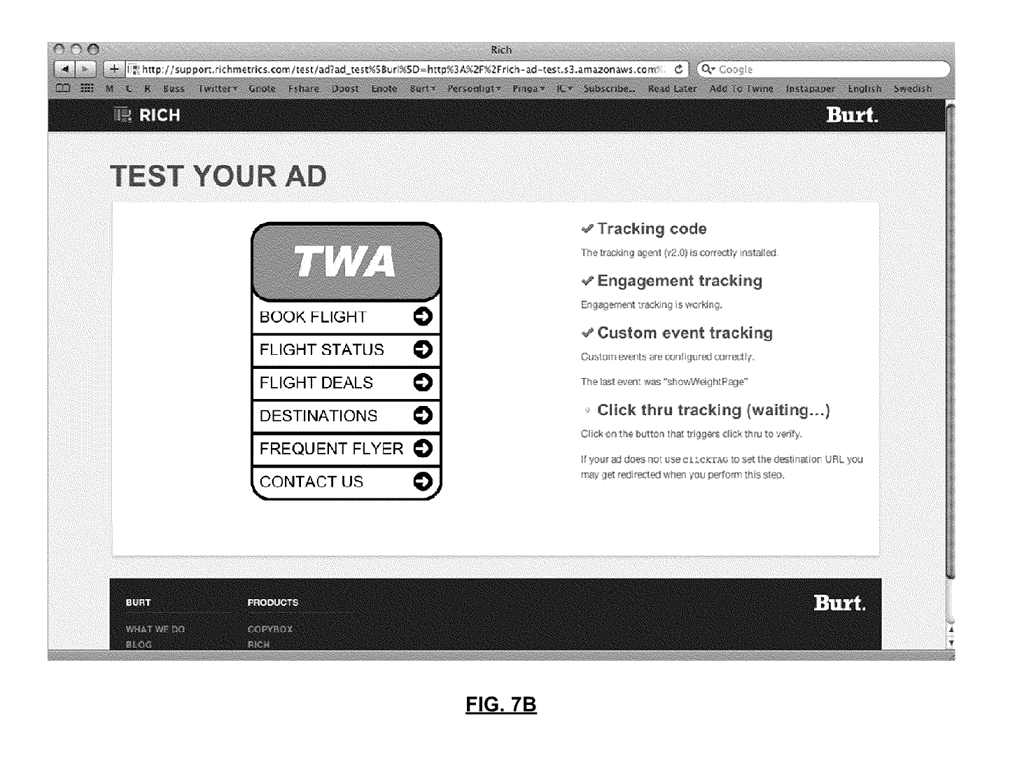

Referring to FIGS. 7A-B, debugging functionality is provided to allow the user to make sure that the advertisement tracking is working properly in a testing stage before it is used live. The user can test an advertisement by uploading a Flash SWF file or test an advertisement uploaded to another server (FIG. 7A). The add is then rendered and its tracking functionality is checked (FIG. 7B).

### Illustrative Code Examples

An illustrative code example for the client's detection of visibility is presented below.

```
// This code is functionally equivalent to the code that runs in
// advertisements that contain the Rich client component. It's been
// reformatted to be more readable, because the actual code is subject
// to some very particular specifications that requires it to be minimal
// in terms of space used, and it has to be both valid ActionScript 2 and
// ActionScript 3. Further, the code makes heavy use of snipplets of
// JavaScript that are embedded as strings and sent from the ad to the web
// page for execution (this is done via the ActionScript External-Interface
// API). For the reasons mentioned above the actual JavaScript code
// has been “minified”, a process that removes unnecessary whitespace and
// reduces the number of charachters used for variable and function names.
In this code listing the equivalent non-minified JavaScript is shown.
// The purpose of this code is to determine if the ad that it is running in is
// visible or not. To do this we need the viewport position and dimensions
// and the position of the ad on the page. The ad already knows its own
// dimensions, but the other values are not available using any ActionScript
// API, so we have to resort to running JavaScript code via
ExternalInterface.
// These two lines get the browser window dimensions by running two
// pieces of JavaScript code. The “...” is in place of the minified code,
// but a readable version can be found below.
var windowWidth : Number = Number(ExternalInterface.call(“...”));
var windowHeight : Number = Number(ExternalInterface.call(“...”));
// This is the JavaScript code used in the two calls above: the code below
// is for finding the width, but the code for finding the height is identical
// save for “height” instead of “width”.
//
//  function windowWidth( ) {
//  if (! window.innerWidth) {
//  if (document.documentElement.clientWidth != 0) {
//  return document.documentElement.clientWidth
//  } else {
//  return document.body.clientWidth
//  }
//  } else {
//  return window.innerWidth;
//  }
//  }
// These two lines get the scroll position of the browser window. Together
// with the window width and height this can be used to find out the part of
// the page that is currently being displayed in the window, i.e. the
// viewport. The “...”is in place of the minified code, but a readable
version can be found below.
var windowScrollX : Number = Number(ExternalInterface.call(“...”));
var windowScrollY : Number = Number(ExternalInterface.call(“...”));
// This is the JavaScript code used in the two calls above: the code below
// is for finding the scroll in x-axis, but the code for finding it in y-axis is
// identical, save for “y” instead of “x” and “top” instead of “left”.
//
//  function windowScrollX( ) {
//  if (window.pageXOffset) {
//  return window.pageXOffset;
//  } else if (document.documentElement) {
//  return document.documentElement.scrollLeft
//  } else if (document.body) {
//  return document.body.scrollLeft
//  } else {
//  return undefined;
//  }
//  }
// This line determines the position of the ad relative to the top left corner
// of the page, and just as the calls above it uses JavaScript to do so. The
// “...” is in place of the minified code, for which a redable version can be
// found below.
var adPosition : Object =
ExternalInterface.call(“...”, ExternalInterface.objectID);
// This is the JavaScript code used in the call above. It finds a node by its
// ID (in the call above it's the ID of the node that contains the ad) and
// iterates over all the parents of that node adding the offsets in x- and
// y-axis as it does so. When it finds a node whose parent is null it has
// reached the top level node and its work is done.
//
//  function findNodePosition(id) {
//  var x = 0;
//  var y = 0;
//
//  var elem = document.embeds[id] || document.getElementById(id);
//
//  while (elem) {
//  x += elem.offsetLeft;
//  y += elem.offsetTop;
//
//  elem = elem.offsetParent;
//  }
//
//  return [x,y]
//  }
// At this point we have all the data that we need to determine if the ad is
// currently visible or not: we have the viewport dimensions and offset (the
// window dimensions and the scroll position), we have the position of the
// ad and the ad already knows its own dimensions. Before we calculate
// the visibility we check all the numbers to see if they are valid. The calls
// above can have returned invalid values. To test if we have an invalid
// position we check if any of the window width, height, scroll x or scroll y
// are invalid numbers (isNaN means “is not a number”), and we make
// sure that the ad position is an array with two elements (the
// findNodePosition function returned the position as a two element array
// where the first element is the x coordinate and the second the y
coordinate.
var positioningError : Boolean = isNaN(windowWidth)
            || isNaN(windowHeight)
            || isNaN(windowScrollX)
            || isNaN(windowScrollY)
            || adPosition == null
            || adPosition.length < 2
            || isNaN(adPosition[0])
            || isNaN(adPosition[1]);
var adVisible : Boolean;
if (! positioningError) {
        // If we have a valid position we do some geometric calculations
        // to see if the rectangle described by the ad on the page overlaps
        // sufficiently with the rectangle described by the viewport. The
        // visibilityThreshold variable determines how much of the ad
        // that needs to be visible for us to consider it visible. It's
        // measured as a percentage of the width or height so the current
        // value of 0.5 means that at least half the width and half the
        height must be within the viewport.
        var visibilityThreshold = 0.5;
        var left : Number = adPosition[0] − windowScrollX +
(visibilityThreshold * adWidth);
        var right : Number = adPosition[0] + adWidth −
        windowScrollX  −
(visibilityThreshold * adWidth);
        var top : Number = adPosition[1] − windowScrollY +
(visibilityThreshold * adHeight);
        var bottom : Number = adPosition[1] + adHeight −
        windowScrollY  −
(visibilityThreshold * adHeight);
        adVisible = (left >= 0 && right <= windowWidth && top >=
0 && bottom <= windowHeight);
    } else {
        // If we have an invalid position we can't tell if the ad is visible
        // or not so the only safe thing to do is to say that it's not.
        adVisible = false;
    }
```

The following illustrative code is used to track custom events:

If an ad is interactive events besides click thru can be tracked. If the ad contains a game, for example, a user might want to know how many clicked the “start game” button, or if it contains a video player, a user might want to know how many clicked “play” and how many watched the movie at least half way through.

RichAgent.trackEvent(“myCustomEvent”, “theNameOfTheObject”);

The first parameter is the name of the event, this will show up in the reports, so it should be choosen carefully. The second parameter is the name of the object that the event should be associated with (for example the button or movie clip that was clicked). This value can be presented in the reports. If the code is called in the context of a movie clip it can be passed as a second parameter, and the client will try to determin the name of the object from the name of the movie clip:

RichAgent.trackEvent(“myCustomEvent”, this);

This variant does not work when using ActionScript 1 event handlers (on (release)), because in those this refers to _root.

The following illustrative code is used to track click-thrus:

To make sure that click thrus are logged a custom event called “clickThru” needs to be sent. Click thrus should be handled something like this:

function onRelease( ) {
getURL(_root.clickTAG, “_blank”);
}

a custom event called “clickThru” should be sent:

```
function onRelease( ) {
  RichAgent.trackEvent(“clickThru”, this);
  getURL(_root.clickTAG, “_blank”);
}
```

The result will be the same, regardless of the selected method, and the RichAgent.clickThru function is implemented more or less like the second example. The benefit with the first method is that it requires the user to do less.

### Custom Segments

To track custom segments RichAgent.trackSegment is called and the segment name and value are passed. This can be done at any time, and as many times as needed. If different values for the same segment names are sent, only the last value will be recorded.

### Example

RichAgent.trackSegment(“interest”, “sport”);

Usually this would be done either when the ad has just started, or in an event handler that is triggered by some user action.

The aggregation and distribution subsystem is preferably implemented by a service provider organization in connection with a centralized server that can process information received from numerous campaigns for different client advertising agencies. Other approaches are also possible, such as using a server specific to an advertising agency or even a combined application that both inserts clients and monitors their communications.

The different parts of the system can be implemented using software running on a general-purpose processor, special-purpose hardware, or a combination of both. In addition, while the system and its operation can be broken into parts as described above, one of ordinary skill in the art would recognize that it is also possible to combine them and/or split them to achieve a different breakdown. In one embodiment, aggregation is performed by a combination that includes Apache, Linux, MySQL, and Hadoop on Amazon AWS (EC2, S3, EBS). This configuration allows for high agility when it comes to scaling.

The present invention has now been described in connection with a number of specific embodiments thereof. However, numerous modifications which are contemplated as falling within the scope of the present invention should now be apparent to those skilled in the art. Therefore, it is intended that the scope of the present invention be limited only by the scope of the claims appended hereto. In addition, the order of presentation of the claims should not be construed to limit the scope of any particular term in the claims.

What is claimed is:

1. A method of evaluating the presentation of advertising content on end-user computer displays, comprising:
sending an integrated advertisement program that includes advertising content through a computer network to end-user computers in response to requests from browsers running on the end-user computers,
accessing the integrated advertisement program on each of the end-user computers after it is received from a server on that computer,
determining by the integrated advertisement program a display attribute of the advertising content in the integrated advertisement program on each of the end-user computers, and
reporting the detected display attribute from each of the end-user computers through the computer network to a monitoring application.

2. The method of claim 1 wherein the step of determining determines visibility display attributes that each relate to whether at least some of the content from the integrated advertising program is displayed on a display associated with an end-user computer.

3. The method of claim 2 wherein the step of detecting a display visibility attribute detects a measure of how much surface area of the advertising content from the integrated advertisement program is visible on the end-user computer.

4. The method of claim 1 wherein the step of determining determines positional display attributes that each relate to a position where the content from the integrated advertising program is presented on a display associated with an end-user computer.

5. The method of claim 4 wherein the step of determining determines positional display attributes based on a position of a canvas containing the content from the integrated advertising program within a browser window.

6. The method of claim 1 wherein the step of detecting a display attribute detects a display duration attribute that relates to how long the advertising content from the integrated advertisement program is visible on the end-user computer.

7. The method of claim 1 further including the steps of aggregating the reported display attributes.

8. The method of claim 7 further including the steps of displaying aggregated display attribute information resulting from the step of aggregating on a computer output device.

9. The method of claim 8 wherein the step of displaying displays the information graphically.

10. The method of claim 7 wherein the step of aggregating derives separate measures of the reported display attributes for different types of content included in different integrated advertisement programs and further including the step of comparing the separate measures.

11. The method of claim 7 further including the step of detecting personal attributes of groups of end users based on the step of reporting and wherein the step of aggregating derives separate measures of the reported display attributes for the different end-user groups.

12. The method of claim 11 wherein the step of detecting detects demographic and regional personal attributes.

13. The method of claim 11 wherein the step of detecting includes accessing the network address of the end-user computer.

14. The method of claim 7 wherein the step of aggregating is user-configurable.

15. The method of claim 7 further including the step of combining reporting links with the content in the integrated advertisement program and wherein the step of combining and the step of aggregating are performed for a same organization.

16. The method of claim 11 further including the step of creating the content to be included in the integrated advertisement program, and wherein the steps of creating, combining, and aggregating are performed for a same organization to provide feedback on the effectiveness of content created in the step of creating.

17. The method of claim 1 wherein the integrated advertisement program is written to operate in a multimedia execution environment.

18. The method of claim 17 wherein the integrated advertisement program is an ActionScript program.

19. The method of claim 17 wherein the integrated advertisement program includes embedded JavaScript.

20. The method of claim 1 further including the steps of combining reporting links with the content in the integrated advertisement program and then providing the integrated advertisement program to different advertisement distribution providers.

21. The method of claim 20 further including the step of storing the integrated advertisement program that includes advertising content on one or more ad servers connected to a computer network and serving the advertisement program from the ad servers.

22. The method of claim 21 wherein the step of reporting operates between the end-user computers and a monitoring server that is separate from the ad servers.

23. The method of claim 1 wherein the step of sending sends the advertisement program in a compiled binary format.

24. The method of claim 1 wherein the step of reporting uses non-cleartext reporting links embedded in the advertisement program.

25. The method of claim 1 wherein the step of sending sends an advertisement program that consists of a single file that includes both content and reporting links.

26. The method of claim 1 wherein the step of reporting includes reporting a validation key.

27. The method of claim 1 wherein the step of reporting a validation key reports a key that includes a portion of the key that identifies a supplier of the content for the integrated advertisement program.

28. An apparatus for evaluating the presentation of advertising content on end-user computer displays, comprising:
an authoring interface operative to enable a user to insert a tracking client with visibility attribute determining logic in an integrated advertisement program that includes advertising content,
an aggregation subsystem operative to receive and aggregate display attributes of the advertizing content from the visibility attribute determining logic in the tracking client in the integrated advertising program, and
a viewer operative to display aggregated display attribute information from the aggregation subsystem.

29. The apparatus of claim 28 further including further viewers and further authoring interfaces operative to insert further tracking clients that include different campaign identifiers, and wherein the aggregation subsystem further includes distribution logic operative to receive and distribute visibility information to different viewers based on the campaign identifiers.

30. The apparatus of claim 29 wherein at least some of the authoring interfaces are each located at one of a plurality of different advertising agencies with one of the viewers and wherein the aggregation and distribution subsystem is located at a location that is geographically remote from the advertising agencies.

31. The apparatus of claim 28 wherein the authoring interface is further operative to insert additional interaction detection logic in the tracking client.

32. An apparatus for evaluating the presentation of advertising content on end-user computer displays, comprising:
tracking client insertion means for inserting means for determining visibility attributes in an integrated advertisement means that includes advertising content,
means for receiving and aggregating display attributes of the advertizing content from the means for determining visibility attributes in the integrated advertising program, and
means for displaying aggregated display attribute information from the means for receiving and aggregating.
